(19) United States
(12) Patent Application Publication
(10) Pub. No.: US 2016/0349480 A1
(43) Pub. Date: Dec. 1, 2016

(54) COMPACT MECHANISM FOR INTER-PUPIL DISTANCE ADJUSTMENT OF VIEWING SYSTEMS

(71) Applicant: BAE SYSTEMS INFORMATION AND ELECTRONIC SYSTEMS INTEGRATION INC., Nashua, NH (US)

(72) Inventor: John R. FRANZINI, Holis, NH (US)

(21) Appl. No.: 15/034,747

(22) PCT Filed: Aug. 27, 2015
(86) PCT No.: PCT/US15/47090

§ 371 Date: May 5, 2016

Related U.S. Application Data
(60) Provisional application No. 62/046,195, filed on Sep. 5, 2014.

(51) Int. Cl. G02B 7/12; G02B 23/18; G02B 23/12

(52) U.S. Cl. CPC G02B 7/12; G02B 23/12; G02B 23/18

(57) ABSTRACT

The present invention provides an apparatus and method for adjusting an inter-pupil distance between eyepieces associated with a pair of telescopic elements in a viewing system with each of the telescopic elements having a corresponding rectilinear focal plane array at the focal plane thereof. The apparatus includes a mechanical drive for moving the focal plane arrays associated with the telescopic elements, wherein the inter-pupil distance is adjusted without skewing an orientation of the focal plane arrays, wherein distortion associated with inter-pupil distance adjustment is eliminated.

### CROSS-REFERENCE TO RELATED APPLICATIONS

This Application claims rights under 35 USC §119(e) from U.S. Application Ser. No. 62/046,195 filed Sep. 5, 2014, the contents of which are incorporated herein by reference. This application is related to provisional application Ser. No. 61/674,432 filed Jul. 23, 2012.

### STATEMENT OF GOVERNMENT INTEREST

This invention was made with United States Government support under Contract No. H94003-04-D-0002/0076 awarded by the United States Department of the Air Force. The United States Government has certain rights in this invention.

### FIELD OF THE INVENTION

This invention relates to the adjustment of inter-pupil distance in a pair of binoculars, and more particularly to this adjustment when the binoculars include a rectilinear focal plane array.

### BACKGROUND OF THE INVENTION

As will be appreciated, in order to accommodate different individuals, the inter-ocular distance or inter-pupil distance (IPD) is normally adjusted in a hinged arrangement in which the two optical telescopes of the binocular are pivoted about the hinge by flattening or sharpening the angle subtended by the hinge arms to the binocular telescopes. While this type of adjustment to accommodate different individuals is commonplace, when binoculars are used in a system in which scenes are imaged onto the human eye, since the eyes are orientation independent, no distortions occur. However, when, for instance, focal plane arrays are used as detectors in the infrared imaging systems, swinging apart the hinged optical telescopes correspondingly affects the rectilinear focal plane arrays at each of the telescopes such that the original horizontal orientations of the focal plane arrays are skewed off axis with respect to one to the other during this type of adjustment. When these focal plane arrays are used to generate images, if their horizontal edges are not along a single horizontal line, there is considerable distortion, which can make focal plane arrays unusable.

It will be appreciated that the optics utilized in binoculars have spherical lens systems, and with visible light, the eye does not recognize orientation of the lens. The eye, for instance, does not know the angle that the image is coming in on, and therefore, at least for the visible region of the electromagnetic spectrum, the eye is orientation independent.

On the other hand, since the eye cannot detect infrared radiation, infrared detecting systems require detector arrays such as focal plane arrays, for instance, available in CCD cameras. These focal plane arrays are rectilinear, with each focal plane array positioned at the focal plane of the corresponding telescopic element. When the infrared binoculars are appropriately adjusted for an individual, it is important that the orientation of the focal plane arrays in each of the telescopic elements is such that the horizontal portion of the focal plane array in one eyepiece is along the same horizontal line as the horizontal portion of the focal plane array in the other telescopic element.

If inter-ocular distance were to be adjusted by the traditional pivot method, maintenance of this horizontal focal plane array orientation would be skewed such that for any binocular system, there would be a large distortion of the image. Moreover, when the human eyes view the images from the focal plane arrays, they cannot mentally accommodate for the misalignment.

Thus, a heretofore unaddressed need exists in the industry to address the aforementioned deficiencies and inadequacies.

### SUMMARY OF THE INVENTION

Embodiments of the present disclosure provide a system and method for adjusting an inter-pupil distance between eyepieces. Briefly described, in architecture, one embodiment of the system, among others, can be implemented as follows. An apparatus is provided for adjusting an inter-pupil distance between eyepieces associated with a pair of telescopic elements in a viewing system with each of the telescopic elements having a corresponding rectilinear focal plane array at the focal plane thereof. The apparatus includes a mechanical drive for moving the focal plane arrays associated with the telescopic elements, wherein the inter-pupil distance is adjusted without skewing an orientation of the focal plane arrays, wherein distortion associated with inter-pupil distance adjustment is eliminated.

The present disclosure can also be viewed as providing methods of adjusting an inter-pupil distance of eyepieces associated with a pair of telescopic elements in a viewing system, wherein the pair of telescopic elements is associated rectilinear focal plane arrays for each of the eyepieces. In this regard, one embodiment of such a method, among others, can be broadly summarized by the following steps: mounting the pair of telescopic elements and the associated rectilinear focal plane arrays whereby the focal plane arrays are constrained in horizontal translation, and whereby the focal plane arrays have co-located center lines; and translating the pair of telescopic elements to adjust the inter-pupil distance of the eyepieces without skewing the rectilinear focal plane arrays during translation, whereby distortion associated with any skewing of the rectilinear focal plane arrays during inter-pupil distance adjustment is minimized.

The present disclosure can also be viewed as providing an apparatus for adjusting inter-pupil distance of viewing systems. Briefly described, in architecture, one embodiment of the apparatus, among others, can be implemented as follows. A viewing system has a pair of eyepieces, wherein the pair of eyepieces is associated with a pair of telescopic elements. A corresponding rectilinear focal plane array is positioned at a focal plane of each of the pair of telescopic elements. A mechanical drive system is coupled to the pair of telescopic elements, wherein actuation of the mechanical drive system moves the focal plane arrays associated with the pair of telescopic elements, wherein the inter-pupil distance is adjusted without skewing an orientation of the focal plane arrays.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagrammatic illustration of a pair of binoculars having a hinged adjustment arrangement for pivoting the two telescopic elements closer or farther away from each other so as to adjust the inter-pupil distance of the associated eyepieces, in accordance with the prior art;

FIGS. 2A and 2B are diagrammatic illustrations of the telescopic elements of the binoculars of FIG. 1 showing the orientation of the corresponding focal plane arrays co-located along a single horizontal line and skewed when the telescopic elements are hingedly moved to adjust inter-pupil distance, in accordance with the prior art;

FIG. 3 is a diagrammatic illustration of a pair of binoculars having a lever adjustment for the inter-pupil distance of the associated eyepieces, in accordance with a first exemplary embodiment of the present disclosure;

FIG. 4 is a diagrammatic illustration of the mounting of the eyepieces of the telescopic elements of the binoculars in FIG. 3 illustrating the horizontal movement of carriages containing these telescopic elements coupled to a rack and pinion arrangement, with the rotation of the pinion moving the eyepieces of the telescopic elements closer together or further apart from each other constrained to a single horizontal direction, thus to maintain the corresponding focal plane arrays to movement in this horizontal direction, in accordance with the first exemplary embodiment of the present disclosure;

FIG. 5 is a cross-sectional diagram of the rack and pinion arrangement of FIG. 4 showing the lever attached to a shaft mounted for rotation in the binocular housing, with the shaft coupled to a pinion gear, in accordance with the first exemplary embodiment of the present disclosure; and,

FIGS. 6A, 6B and 6C are top views of the rack and pinion arrangement of FIG. 4 showing that, with the rotation of the pinion gear, the inter-pupil distance of the eyepieces associated with the telescopic elements is increased with a clockwise rotation of the pinion gear and decreased with counter clockwise pinion gear rotation, in accordance with the first exemplary embodiment of the present disclosure.

### DETAILED DESCRIPTION

In order to achieve horizontal inter-pupil distance adjustment, in the subject invention, each of the binocular telescopic elements is mounted for horizontal translation on a carriage, with the adjustment being provided by a rack and pinion arrangement actuated by a lever on the top of the binoculars. The lever is mechanically coupled to a pinion gear such that with rotation of the gear, the associated racks move in opposite directions. Each of these racks is mechanically coupled to a horizontally translatable carriage so as to move the telescopic elements closer to each other or further from each other, constrained to horizontal movement.

Since each of the telescopic elements carries its own focal plane array, and since the focal plane array has a horizontal edge parallel to the direction of moment of its carriage, adjustment of the inter-pupil or inter-ocular distance does not require skewing or canting of the focal plane arrays. The result is that inter-ocular distance can be adjusted without distortion. While the subject invention will be described in terms of its use in infrared binoculars, the subject invention relates to any type of binocular which utilizes rectilinear focal plane arrays. Thus, the subject invention provides for a compact mechanism of IPD adjustment in viewing systems. The present invention in one embodiment is an apparatus for adjusting the IPD of viewing systems comprised of a housing unit containing a pair of telescopic components, a switch lever, a shaft coupled to the shift lever, a gear secured to the shaft, and pupil distance lever racks actuated by the gear and coupled to respective telescopic components.

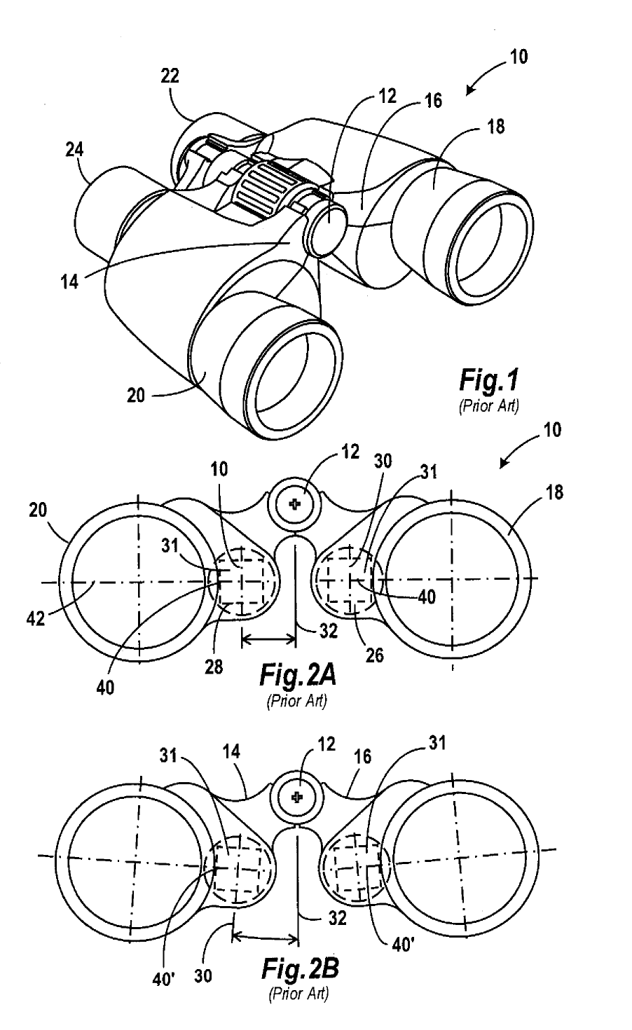

Referring now to the figures, FIG. 1 is a diagrammatic illustration of a pair of binoculars having a hinged adjustment arrangement for pivoting the two telescopic elements closer or farther away from each other so as to adjust the inter-pupil distance of the associated eyepieces, in accordance with the prior art. As shown, a conventional pair of binoculars 10 have a central pivot 12 and a pair of pivot arms 14, 16 by which telescopic elements 18, 20 can be pivoted either closer together or farther away from each other. The resulting motion correspondingly moves eyepieces 22, 24 either closer together or farther away from each other.

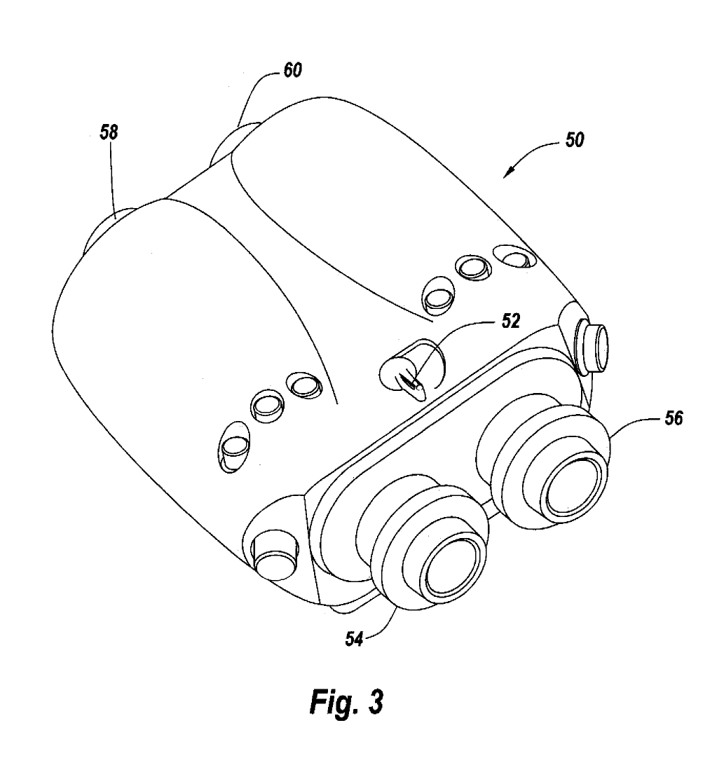

FIGS. 2A and 2B are prior art diagrammatic illustrations of the telescopic elements of the binoculars of FIG. 1 showing the orientation of the corresponding focal plane arrays co-located along a single horizontal line and skewed when the telescopic elements are hingedly moved to adjust inter-pupil distance, in accordance with the prior art. In FIG. 2A, the binoculars 10 have corresponding rectilinear focal point arrays 26, 28, each having a vertical centerline 30 spaced from a centerline 32 corresponding to the centerline of the binoculars 10. Here, the focal plane arrays 26, 28 are illustrated by dotted boxes 31. The distance between the centerlines 30, 32 refers to one-half the inter-pupil distance. When it is desired to increase the inter-pupil distance, as illustrated in FIG. 2B, arms 14, 16 are moved apart so as to flatten the angle subtended by center pivot 12 and increase the distance between centerlines 30, 32, thereby to increase the inter-pupil distance.

However, as can be seen, the original horizontal centerlines 40 of the focal plane arrays 31 which lie along horizontal line 42, are now skewed, as illustrated at 40′ in FIG. 2B. Thus, lines 40′ are not only not parallel to each other, but they also are not horizontal. The result is that images collected on focal plane arrays 31 will be distorted and unusable once the original horizontal parallel orientations are disturbed through the adjustment of the binoculars of FIG. 1.

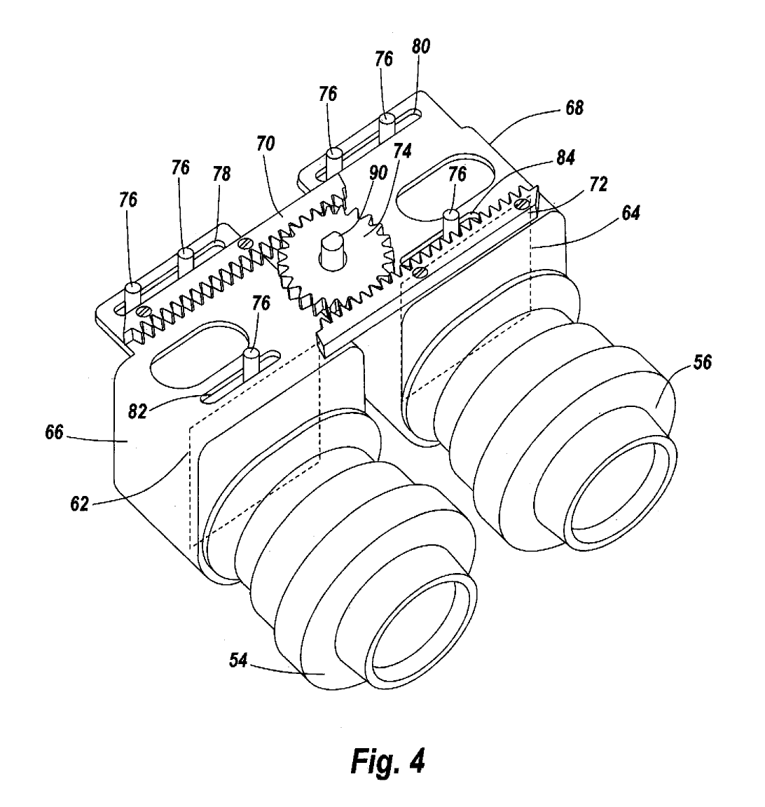

FIG. 3 is a diagrammatic illustration of a pair of binoculars having a lever adjustment for the inter-pupil distance of the associated eyepieces, in accordance with a first exemplary embodiment of the present disclosure. In one embodiment of the present disclosure, a pair of binoculars 50 is provided with an inter-pupil distance control lever 52 which controls the distance of eyepieces 54, 56 associated with telescopic elements 58, 60. It is a purpose of this control lever and adjustment system to maintain the parallel orientation of the focal plane arrays associated with telescopic elements 58, 60 during adjustment. In one embodiment, the IPD adjustability may range from 2.17 inches to 2.84 inches to precisely adjust to the IPD for the middle 90% of the male population.

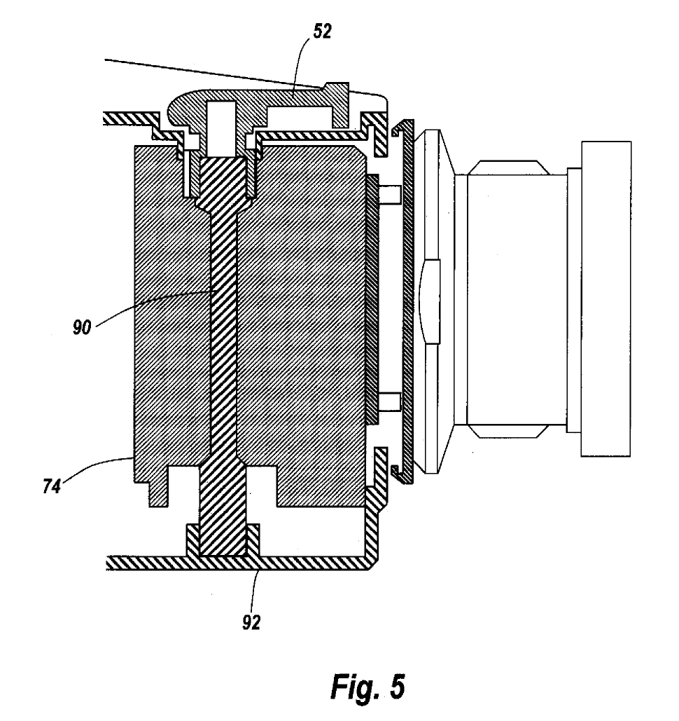

FIG. 4 is a diagrammatic illustration of the mounting of the eyepieces of the telescopic elements of the binoculars in FIG. 3 illustrating the horizontal movement of carriages containing these telescopic elements coupled to a rack and pinion arrangement, with the rotation of the pinion moving the eyepieces of the telescopic elements closer together or farther apart from each other constrained to a single horizontal direction, thus to maintain the corresponding focal plane arrays to movement in this horizontal direction, in accordance with the first exemplary embodiment of the present disclosure. The focal plane arrays 62, 64 are shown in dotted outline within carriages 66, 68 on to which are mounted corresponding eyepieces 54, 56. Here, it will be seen that carriages 66, 68 are coupled to racks 70, 72 that cooperate with a pinion gear 74 to move carriages 66, 68 and corresponding eyepieces 54, 56 either closer together or farther apart. Each of the carriages 66, 68 has pins 76 which project through respective slots 78, 80, 82 and 84 to limit the motion of the carriages, and thus the corresponding eyepieces 54, 56 and focal point arrays 62, 64.

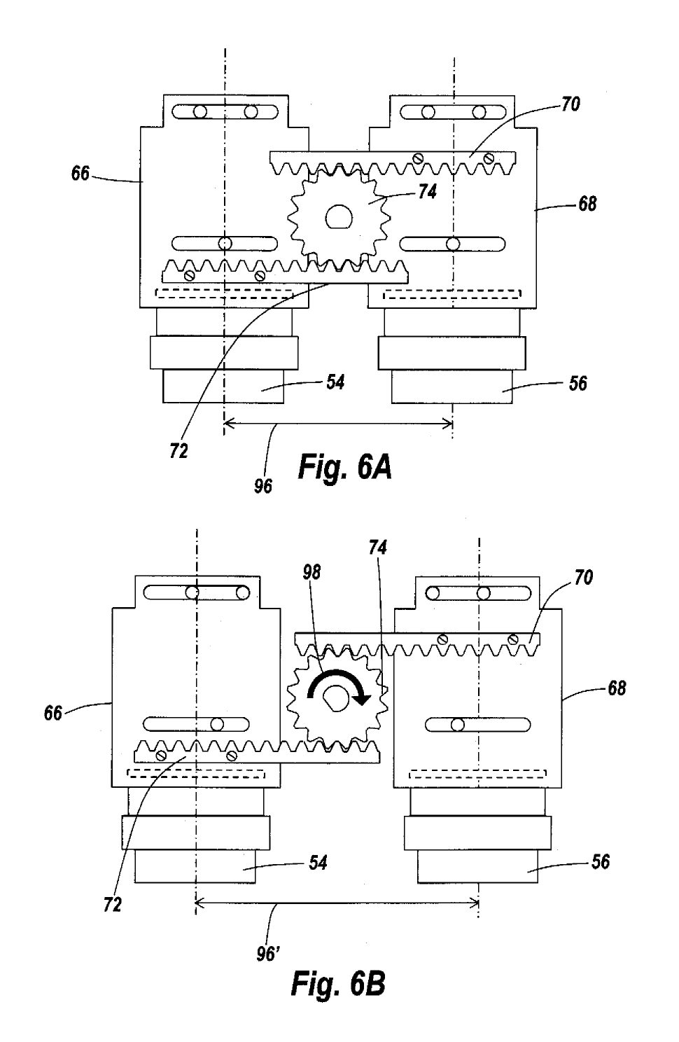

FIG. 5 is a cross-sectional diagram of the rack and pinion arrangement of FIG. 4 showing the lever attached to a shaft mounted for rotation in the binocular housing, with the shaft coupled to a pinion gear, in accordance with the first exemplary embodiment of the present disclosure. As is shown in FIG. 5, lever 52 may be connected to a shaft 90 mounted for rotation to chassis 92, with pinion 74 coupled to shaft 90. Accordingly, actuation of the lever 52 may rotate the shaft 90, which in turn, causes movement of the pinion gear 74, which can then move the racks 70, 72 (FIG. 4).

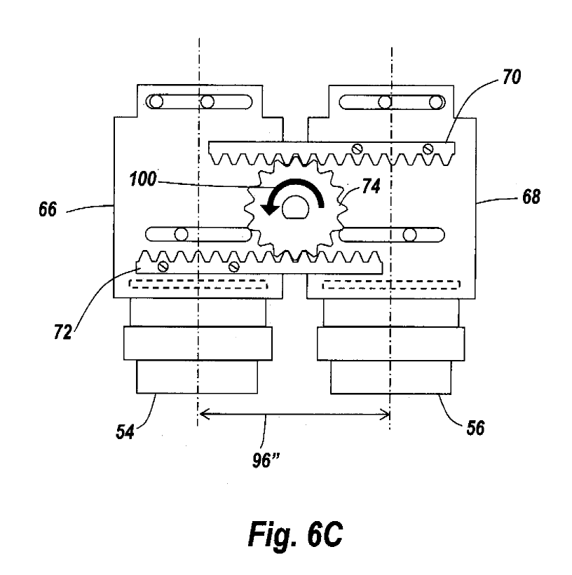

FIGS. 6A, 6B and 6C are top views of the rack and pinion arrangement of FIG. 4 showing that, with the rotation of the pinion gear, the inter-pupil distance of the eyepieces associated with the telescopic elements is increased with a clockwise rotation of the pinion gear and decreased with counter clockwise pinion gear rotation, in accordance with the first exemplary embodiment of the present disclosure. As shown in FIGS. 6A, 6B, and 6C, the pinion gear 74 and racks 70, 72 can be used to move eyepieces 54, 56 between various positions. In FIG. 6A, the eyepieces 54, 56 are spaced apart by inter-pupil distance 96. When pinion gear 74 is rotated clockwise, as indicated by arrow 98, racks 70, 72 move apart, thereby increasing to inter-pupil distance 96′, as illustrated. Moreover, as illustrated in FIG. 6C, when pinion gear 74 is rotated counterclockwise, as indicated by arrow 100, racks 70, 72 move to decrease the inter-pupil distance 96″.

Thus, in one exemplary embodiment, the apparatus may include five main components: the upper housing, the switch lever, the shaft, the gear, and the two racks. The housing unit may be the casing of the device. With respect to FIGS. 2-6C, the switch lever 52 may be operated by the user when adjustment of the IPD is desired. The shaft 90 may be rigidly connected to switch lever 52. Therefore, when the user operates the switch lever 52, the shaft 90 necessarily rotates. The pinion gear 74 is rigidly connected to the shaft. As such, it rotates when the shaft 90 rotates, which rotates as the switch lever 52 rotates. The two racks 70, 72 operate as one unit adjusting the two different eyepieces 54, 56. These racks 70, 72 are driven by the pinion gear 74. As such, when the pinion gear 74 rotates, the racks 70, 72 translate the rotational movement to linear movement. The racks 70, 72 are connected at opposite sides of the pinion gear 74 such that the racks 70, 72 move in opposite directions as the pinion gear 74 rotates.

It is noted that the subject arrangement moves the associated focal plane arrays such that their orientation is always parallel one to the other regardless of the inter-ocular adjustment. Moreover, while a rack and pinion arrangement has been discussed, other mechanical or electromechanical linkages which move the telescopic elements and associated eyepieces such that the associated focal plane arrays are parallel are within the subject matter of this invention. Further, it is possible to move only one of the telescopic elements and associated eyepiece with respect to a fixed telescopic element and eyepiece such that the associated focal plane arrays maintain their parallel orientation during the inter-ocular adjustment.

It is further noted that the present invention does not require vertical movement of the eyepieces because the viewing area inside the device is axisymmetric and there is no electronic display. Unlike other systems, this invention does not rotate or distort the imagery because it remains parallel. Furthermore, it provides smooth operation throughout its range. As such, although the preferred embodiment of the present invention was designed to meet the needs of thermal infrared (IR) imaging, it is applicable to other viewing systems.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. An apparatus for adjusting an inter-pupil distance between eyepieces associated with a pair of telescopic elements in a viewing system with each of the telescopic elements having a corresponding rectilinear focal plane array at the focal plane thereof, the apparatus comprising:
a mechanical drive for moving the focal plane arrays associated with the telescopic elements, wherein the inter-pupil distance is adjusted without skewing an orientation of the focal plane arrays, wherein distortion associated with inter-pupil distance adjustment is eliminated.

2. The apparatus of claim 1, wherein said mechanical drive includes a rack and pinion.

3. The apparatus of claim 2, further comprising a switch lever manually actuated by a user of the viewing system, and a shaft coupled to the switch lever and the pinion, wherein by rotating the switch lever, the shaft and pinion gear moves an associated rack, wherein each associated rack is mechanically coupled to a different one of the telescopic elements.

4. The apparatus of claim 3, wherein each of the telescopic elements is secured to a translatable carriage, and wherein different ones of the racks are coupled to different ones of the carriages.

5. The apparatus of claim 4, wherein the carriages are constrained to operate only in a single horizontal direction, wherein movement of the carriages in the single horizontal direction maintains an orientation of corresponding focal plane arrays, wherein the focal plane arrays are maintained parallel to each other.

6. The apparatus of claim 5, wherein the focal planes have co-located horizontal center lines.

7. A method for adjusting an inter-pupil distance of eyepieces associated with a pair of telescopic elements in a viewing system, wherein the pair of telescopic elements is associated rectilinear focal plane arrays for each of the eyepieces, the method comprising the steps of:
mounting the pair of telescopic elements and the associated rectilinear focal plane arrays whereby the focal plane arrays are constrained in horizontal translation, and whereby the focal plane arrays have co-located center lines; and, translating the pair of telescopic elements to adjust the inter-pupil distance of the eyepieces without skewing the rectilinear focal plane arrays during translation, whereby distortion associated with any skewing of the rectilinear focal plane arrays during inter-pupil distance adjustment is minimized

8. The method of claim 7, wherein the mounting and translating steps utilize a rack and pinion.

9. The method of claim 7, wherein the telescopic elements are translated simultaneously with the adjustment.

10. The method of claim 7, wherein one of the telescopic elements is fixed and the other of the telescopic elements is moved relative to the fixed telescopic element.

11. An apparatus for adjusting inter-pupil distance of viewing systems, the apparatus comprising:
a viewing system having a pair of eyepieces, wherein the pair of eyepieces is associated with a pair of telescopic elements;
a corresponding rectilinear focal plane array at a focal plane of each of the pair of telescopic elements; and
a mechanical drive system coupled to the pair of telescopic elements, wherein actuation of the mechanical drive system moves the focal plane arrays associated with the pair of telescopic elements, wherein the inter-pupil distance is adjusted without skewing an orientation of the focal plane arrays.

12. The apparatus of claim 11, wherein said mechanical drive includes a rack and pinion.

13. The apparatus of claim 12, further comprising a switch lever manually actuated by a user of the viewing system, and a shaft coupled to the switch lever and the pinion, wherein by rotating the switch lever, the shaft and pinion gear moves an associated rack, wherein each associated rack is mechanically coupled to a different one of the telescopic elements.

14. The apparatus of claim 13, wherein each of the telescopic elements is secured to a translatable carriage, and wherein different ones of the racks are coupled to different ones of the carriages.

15. The apparatus of claim 14, wherein the carriages are constrained to operate only in a single horizontal direction, wherein movement of the carriages in the single horizontal direction maintains an orientation of corresponding focal plane arrays, wherein the focal plane arrays are maintained parallel to each other.
